(19) United States
(12) Patent Application Publication
(10) Pub. No.: US 2026/0199975 A1
(43) Pub. Date: Jul. 16, 2026

(54) LAYERED STRUCTURE MANUFACTURING DEVICE AND LAYERED STRUCTURE MANUFACTURING METHOD

(71) Applicant: TAIYO NIPPON SANSO CORPORATION, Tokyo (JP)

(72) Inventors: Hiroki AMANO, Tokyo (JP); Hirotaka MANGIYOU, Tokyo (JP); Madoka NAKAMURA, Tokyo (JP)

(21) Appl. No.: 19/126,067

(22) PCT Filed: Oct. 31, 2023
(86) PCT No.: PCT/JP2023/039255

§ 371 Date: Apr. 30, 2025

(30) Foreign Application Priority Data
Nov. 11, 2022 (JP) 2022-181399

(51) Int. Cl. B22F 10/14; B22F 10/32; B22F 10/60; B22F 10/73; B22F 12/00; B22F 12/33; B22F 12/90; B33Y 10/00; B33Y 30/00; B33Y 40/20

(52) U.S. Cl. CPC B22F 10/14; B22F 10/32; B22F 10/60; B22F 10/73; B22F 12/33; B22F 12/38; B22F 12/90; B33Y 10/00; B33Y 30/00; B33Y 40/20; B22F 2998/10

(57) ABSTRACT

An object of the present invention is to provide a layered structure manufacturing device that enables simple manufacturing of a layered structure. The present invention provides a layered structure manufacturing device for manufacturing a layered structure, comprising: a housing (2) for forming a shield gas atmosphere in an inner space thereof; an analysis unit (3) for analyzing components of the shield gas atmosphere; a control unit (4) having the function of controlling the shield gas atmosphere to have required components; a molding section (7) for forming molded solidified layers (25a) and molding a layered body (25) in which the molded solidified layers (25a) are layered; a drying section (8) for heating and drying the layered body (25); a powder removal section (9) for removing unnecessary raw material powder from the dried layered body (25); and a powder recovery section (10) for recovering the unnecessary raw material powder, wherein the molding section (7), the drying section (8), the powder removal section (9), and the powder recovery section (10) are located in the inner space of the housing (2).

### TECHNICAL FIELD

The present invention relates to a layered structure manufacturing device and a layered structure manufacturing method.

### BACKGROUND ART

Like additive manufacturing techniques, layered structures can be manufactured using energy rays. For example, based on any CAD (Computer Aided Design) data, metal layers obtained by irradiating a laser are sequentially layered to manufacture a layered structure of any shape as a three-dimensional structure.

Additive manufacturing technology is being applied to the field of industrial equipment including aircraft-related components, and the field of medical equipment, and is attracting attention as a promising technology. Recently, a layered structure manufacturing method using the binder jet method has been proposed, in which a layered structure is obtained by layering multiple molded solidified layers formed by applying a binder to a powder bed of raw powder.

However, in the conventional layered structure manufacturing method using the binder jet method, there was a problem in that the powder present in the molding stage other than the layered structure could cause a dust explosion or react with air components or moisture.

Patent Document 1 discloses a technology for preventing dust explosions by forming a resin coating film on the surface of fine particles that become the raw powder.

Patent Document 2 discloses a technology for changing the conditions for forming the powder layer depending on the moisture content of the raw powder, as the liquid bridging force acting between particles changes depending on the moisture content.

Patent Document 3 discloses a technology for ALD coating of active metals to allow them to be handled safely in air or in humid environments.

### PRIOR ART DOCUMENTS

### Patent Documents

Patent Document 1: Japanese Unexamined Patent Application, First Publication No. 2021-011107
Patent Document 2: Japanese Unexamined Patent Application, First Publication No. 2020-082432
Patent Document 3: Published Japanese Translation No. 2021-504568 of the PCT International Publication

### SUMMARY OF INVENTION

### Problem to be Solved by the Invention

However, in Patent Documents 1 to 3, the conventional binder jet method for forming a layered structure requires surface treatment of the raw powder and changes to the conditions for forming the powder bed, making it difficult to perform simple formation. In addition, the binder scatters and the solvent contained in the binder vaporizes and is released to the outside, which can cause health hazards if workers inhale the binder or vaporized solvent.

The present invention has been made in consideration of the above circumstances, and an object of the present invention is to provide a layered structure manufacturing device and a layered structure manufacturing method that enable simple manufacturing of a layered structure and prevent health hazards.

### Means for Solving the Problem

In order to solve the above problems, the present invention has the following configuration.

[1] A layered structure manufacturing device for manufacturing a layered structure by layering multiple molded solidified layers formed by applying a binder to a powder bed of raw material powder, comprising:
a housing for forming a shield gas atmosphere in an inner space thereof;
an analysis unit for analyzing components of the shield gas atmosphere;
a control unit having the function of controlling the shield gas atmosphere to have required components;
a molding section for forming molded solidified layers and molding a layered body in which the molded solidified layers are layered;
a drying section for heating and drying the layered body;
a powder removal section for removing unnecessary raw material powder from the dried layered body; and
a powder recovery section for recovering the unnecessary raw material powder,
wherein the molding section, the drying section, the powder removal section, and the powder recovery section are located in the inner space of the housing.

[2] The layered structure manufacturing device according to [1],
wherein the housing has a plane that divides the space of the housing in the vertical direction, and
wherein the molding section, the drying section, and the powder removal section are located in the space above the plane.

[3] The layered structure manufacturing device according to [2],
wherein the molding section, the drying section, and the powder removal section are arranged in this order in one direction on the plane.

[4] The layered structure manufacturing device according to [3],
wherein the layered structure manufacturing device further comprises a first guide rail arranged along the one direction, and
wherein a molding container having a molding stage moves on the first guide rail.

[5] The layered structure manufacturing device according to [4],
wherein the powder removal section has a lifting mechanism that moves the molding stage up and down in the vertical direction.

[6] The layered structure manufacturing device according to [4],
wherein the layered structure manufacturing device further comprises a second guide rail arranged along another direction intersecting the one direction on the plane,
wherein the first guide rail and the second guide rail intersect between the molding section and the drying section, and
wherein the molding container moves on the first guide rail and the second guide rail.

[7] The layered structure manufacturing device according to any of [1] to [6],
wherein the analysis unit has either one or both of a moisture concentration meter and a hydrogen concentration meter. [8] The layered structure manufacturing device according to any of [1] to [6],
wherein the layered structure manufacturing device further comprises a nitrogen PSA device using air as a raw material as a shield gas supply source for supplying a shield gas into the housing.

[9] A layered structure manufacturing method for manufacturing a layered structure by layering multiple molded solidified layers formed by applying a binder to a powder bed of raw material powder, comprising:
a molding step of forming molded solidified layers and molding a layered body by layering the molded solidified layers in a shielding gas atmosphere containing required components;
a drying step of heating and drying the layered body in a shielding gas atmosphere containing required components; and
a removal step of removing unnecessary raw material powder from the layered body that has been dried in a shielding gas atmosphere containing required components.

[10] The layered structure manufacturing method according to [9],
wherein either or both of a moisture concentration and a hydrogen concentration of the shield gas atmosphere are controlled in the molding step, the drying step, and the removal step.

[11] The layered structure manufacturing method according to [9],
wherein the shield gas atmosphere contains oxygen in the molding step, the drying step, and the removal step.

### Effects of the Invention

The layered structure manufacturing method according to the present invention makes it easy to manufacture a layered structure and can prevent health hazards.

### BRIEF DESCRIPTION OF THE DRAWINGS

FIG. 1 is a block diagram showing an example of the configuration of a layered structure manufacturing device applicable to an embodiment of the present invention.

FIG. 2 is a side view showing a housing constituting a layered structure manufacturing device applicable to an embodiment of the present invention.

FIG. 3 is a top view showing a housing constituting a layered structure manufacturing device applicable to an embodiment of the present invention.

FIG. 4 is a schematic cross-sectional view showing a molding unit constituting the layered structure manufacturing device of an embodiment of the present invention during powder bed formation.

FIG. 5 is a schematic cross-sectional view showing a molding unit constituting the layered structure manufacturing device of an embodiment of the present invention during binder application.

### DETAILED DESCRIPTION OF THE PREFERRED EMBODIMENTS

Hereinafter, a layered structure manufacturing device and a layered structure manufacturing method according to an embodiment of the present invention will be described in detail with reference to the drawings. Note that the drawings used in the following description may show characteristic parts in an enlarged scale for the sake of convenience in order to make the characteristics easier to understand, and the dimensional ratios of each component may not necessarily be the same as in reality.

The meanings and definitions of terms used in the present description are as follows.

A numerical range expressed as “~” means that the numerical range has the numbers before and after ~ as the lower and upper limits.

### <Layered Structure Manufacturing Device>

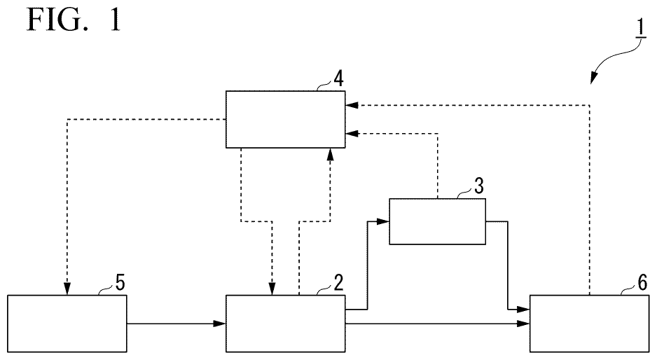

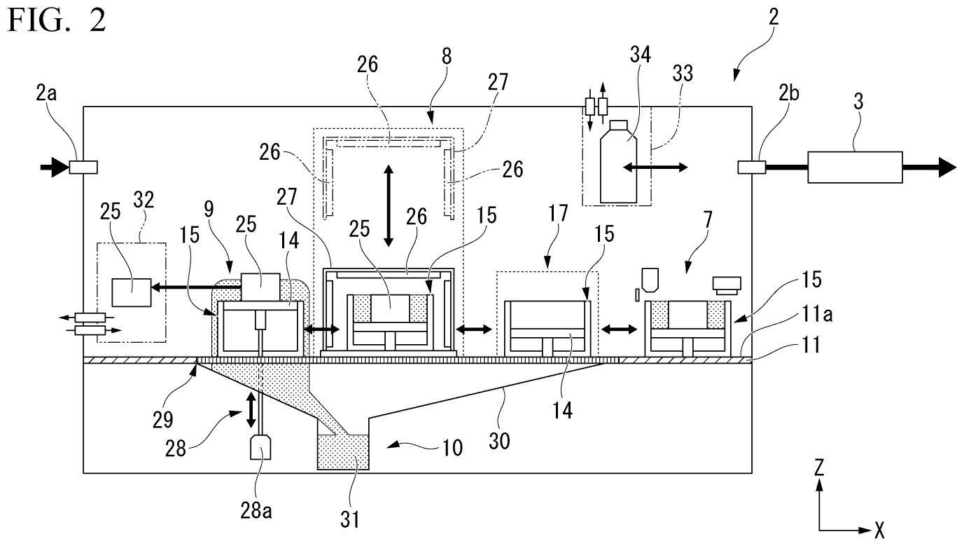

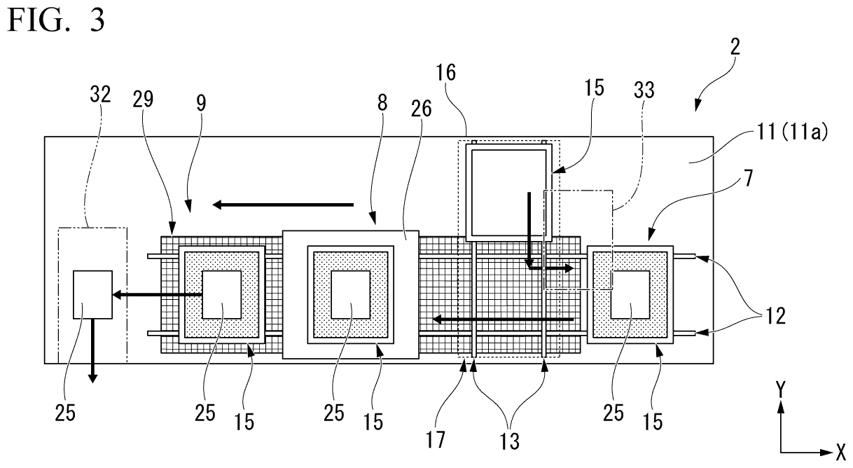

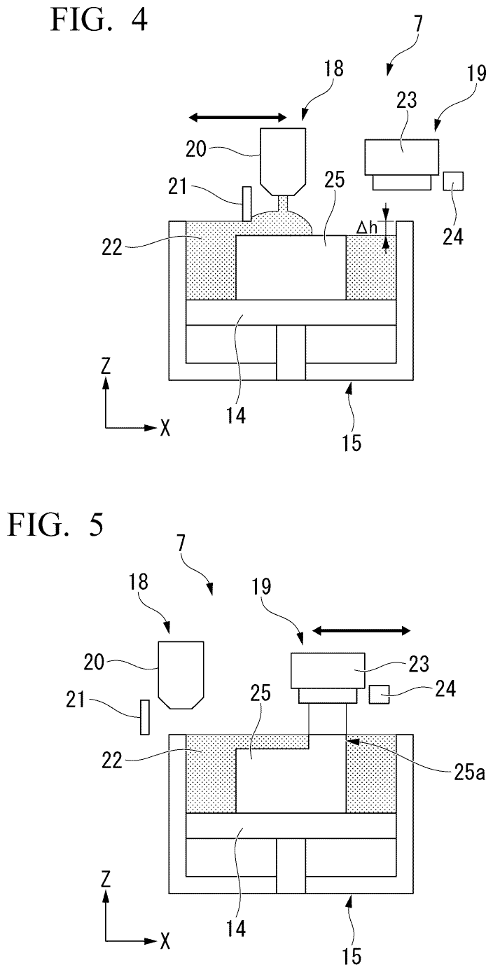

First, the configuration of a layered structure manufacturing device, which is an embodiment according to the present invention, will be described. FIG. 1 is a block diagram showing the configuration of the layered structure manufacturing device of the present embodiment. FIG. 2 is a side (front) view showing a housing that constitutes the layered structure manufacturing device of the present embodiment. FIG. 3 is a top view showing a housing that constitutes the layered structure manufacturing device of the present embodiment. FIG. 4 and FIG. 5 are schematic cross-sectional views showing a molding section that constitutes the layered structure manufacturing device of the present embodiment.

As shown in FIG. 1, a layered structure manufacturing device (hereinafter, this may simply be referred to as “manufacturing device”) 1 of the present embodiment is roughly configured to include a housing 2, an analysis unit 3, a control unit 4, a shield gas supply unit (shielding gas supply source) 5, and an exhaust gas treatment unit 6. Note that the solid arrows shown in FIG. 1 indicate the direction of gas (gas) flow, and the dotted arrows indicate the direction of electrical signal transmission.

The manufacturing device 1 is a so-called binder jet type manufacturing device that obtains a layered structure by layering multiple molded solidified layers formed by applying a binder to a powder bed of raw material powder in a shield gas atmosphere in the housing 2.

As shown in FIGS. 2 and 3, the housing 2 has an airtight space inside, in which a molding section 7, a drying section 8, a powder removal section 9, and a powder recovery section 10 are arranged. This structure allows a series of operations to be performed within the airtight housing 2. This eliminates the need for surface treatment of the raw powder or changing the conditions for forming the powder bed, making it possible to easily shape the product. Furthermore, this prevents workers from inhaling scattered binder or vaporized solvent, which can pose health risks.

A work stage 11 is located inside the housing 2. The work stage 11 divides the space inside the housing 2 into an upper space and a lower space.

The upper surface (plane) 11a of the work stage 11 is flat. As shown in FIG. 3, a first guide rail 12 is disposed on the upper surface 11a of the work stage 11 along the X-axis direction (one direction), and a second guide rail 13 is disposed on the upper surface 11a of the work stage 11 along the Y-axis direction (the other direction).

In the manufacturing device 1 of the present embodiment, as shown in FIGS. 2 and 3, a molding container 15 having a molding stage 14 can be transported along the first guide rail 12 and the second guide rail 13 manually or automatically by a control signal from a control unit 4. That is, the first guide rail 12 and the second guide rail 13 are transport rails for the molding container 15 and are part of a transport mechanism for the molding container 15.

Of the molding section 7, the drying section 8, the powder removal section 9, and the powder recovery section 10, the molding section 7, the drying section 8, and the powder removal section 9 are arranged in this order on the first guide rail 12. That is, the molding section 7, the drying section 8, and the powder removal section 9 are arranged on the upper surface 11a of the work stage 11 (the upper space inside the housing 2) along the X-axis direction.

Therefore, by moving the molding container 15 along the first guide rail, the molding container 15 can be transported to any area of the molding section 7, the drying section 8, and the powder removal section 9 depending on a manufacturing step.

The first guide rail 12 and the second guide rail 13 intersect between the molding section 7 and the drying section 8. This allows the transport direction of the molding container 15 to be changed at the position where the first guide rail and the second guide rail intersect. Therefore, the molding container 15 before processing can be kept waiting on the second guide rail 13, and can be moved from the second guide rail 13 to the first guide rail 12 at any time, and the processed molding container 15 can be moved (waiting or retreating) from the first guide rail 12 to the second guide rail 13. This makes it possible to simultaneously process multiple processes in parallel, and multiple layered structures can be formed under the same conditions, making it possible to perform simpler molding without changing the formation conditions of the powder bed.

As shown in FIG. 3, the housing 2 may be configured to include a housing upper opening door 16 that constitutes part of the upper side of the housing 2 and is a cover that covers the upper part of the work stage 11. By opening the housing upper opening door 16 upward as necessary, the molding container 15 can be directly attached and detached from the work stage 11.

That is, the second guide rail 13 constitutes a replacement section 17 for the molding container 15. The replacement section 17 is located on the first guide rail 12 between the molding section 7 and the drying section 8, as shown in FIGS. 2 and 3.

As shown in FIGS. 4 and 5, the molding section 7 has a powder bed forming portion 18 and a binder applying portion 19. The powder bed forming portion 18 and the binder applying portion 19 are electrically connected to the control unit 4, and move back and forth in the X-axis and Y-axis directions in response to control signals from the control unit 4.

The powder bed forming portion 18 has a powder storage portion 20 and a recoater 21. The powder bed forming portion 18 forms a powder bed 22 of raw material powder on the molding stage 14 of the molding container 15 located in the molding section 7.

The powder storage portion 20 stores raw material powder to be supplied to the molding container 15 to form the powder bed 22 on the molding stage 14. A nozzle for discharging the raw material powder is provided below the powder storage portion 20. As the powder storage portion 20 moves, the raw material powder is deposited above the upper surface of the molding stage 14 as shown in FIG. 4.

The raw material powder is not particularly limited and can be appropriately selected depending on the application of the layered structure. Examples of the raw material powder include powders of various metals such as magnesium, calcium, chromium, platinum, gold, silver, copper, iron, manganese, molybdenum, cobalt, nickel, hafnium, niobium, titanium, and aluminum, and alloys thereof, and ceramic powders. Examples of the ceramic powder include powders of silicides, oxides, nitrides, carbides, and borides of the metals above. The raw material powder may be any one of these, or may be a mixed powder of two or more of these, or may be a mixed powder of a raw material powder and a ceramic powder.

In the present embodiment, it is preferable to use a precious metal such as gold or platinum, a titanium alloy, or an aluminum alloy as the raw material powder.

The particle size of the raw material powder is not particularly limited, and may be, for example, about 1~200 μm.

As shown in FIG. 4, the recoater 21 flattens the surface of the raw material powder (that is, the surface of the powder bed 22) deposited on the upper surface of the molding stage 14. In this way, the powder bed 22 of the raw material powder is formed on the molding stage 14 of the molding container 15 located in the molding section 7.

The powder bed 22 is formed by depositing the raw material powder on the upper surface of the molding stage 14 in the molding container 15. The molding stage 14 has a function of moving up and down in the vertical direction (Z-axis direction) inside the molding container 15. Therefore, the powder bed 22 of the raw material powder is movable up and down, that is, in the Z-axis direction, inside the housing 2.

To form the powder bed 22, first, the molding stage 14 of the molding container 15 located in the molding section 7 is lowered in the Z-axis direction by an arbitrary height Δh. Next, a raw material powder layer is deposited on the upper surface of the molding stage 14 in the molding container 15, and the surface of the deposited raw material powder layer is smoothed by the recoater 21. In this way, the powder bed 22 in which the raw material powder layer is deposited to an arbitrary deposition thickness Δh is formed.

The molding stage 14 in the molding container 15 located in the molding section 7 is electrically connected to the control unit 4. Therefore, the lowering distance (movement amount) of the molding stage 14 is controlled in accordance with a control signal (instruction) from the control unit 4 so that the deposition thickness of the powder bed 22 becomes Δh.

The binder applying portion 19 has a binder applying nozzle 23 and a heat source section 24 for solidifying the binder. The binder applying portion 19 selectively applies a binder to the powder bed 22 of the raw material powder formed on the molding stage 14 in order to bind the raw material powder particles together.

There are no particular limitations on the binder applying nozzle 23, so long as it is a mechanism that selectively applies the binder supplied from the binder reservoir not shown in figures to any desired position on the powder bed 22.

The heat source 24 is not particularly limited, so long as it is a heat source that is capable of solidifying the binder to form the molded solidified layer 25a.

The binder is a binding material that binds the raw material powders together. The binder is not particularly limited as long as it can be applied from the binder application nozzle 23, and can be appropriately selected depending on the type of raw material powder and layered structure. As the binder, for example, a liquid resin or a solution in which a resin component is dissolved in a solvent (specifically, a mixed solution containing 10~25% ethylene glycol, a mixed solution containing 2.5~10% ethylene glycol monobutyl ether, and the like) can be used.

As shown in FIG. 5, the molded solidified layer 25a is formed by solidifying the binder applied to a raw material powder layer deposited on the upper surface (that is, the upper surface of the molding stage 14) of the layered body 25 (green part) located on the powder bed 22 in the molding container 15. In other words, the molding section 7 forms the molded solidified layer 25a and shapes the layered body 25 in which a plurality of the molded solidified layers 25a are layered.

As shown in FIGS. 2 and 3, the drying section 8 is located on the first guide rail 12, and dries the layered body 25 formed in the molding section 7. Specifically, the drying section 8 has a heat source 26 for drying the layered body 25.

The heat source 26 is attached to a heating chamber 27 that surrounds the molding container 15 located in the drying section 8.

The heating chamber 27 can be raised and lowered vertically (in the Z-axis direction) as shown in FIG. 2. With the heating chamber 27 raised upward in the Z-axis direction, the molding container 15 is transported from the molding section 7 to the drying section 8 using the first guide rail 12, and then the heating chamber 27 is lowered downward in the Z-axis direction to store the molding container 15 inside the heating chamber 27. In this state, the layered body 25 is heated and dried by the heat source 26.

According to the manufacturing device 1 of the present embodiment, since the molding section 7 and the drying section 8 are located within the housing 2, the layered body can be dried in a shield gas atmosphere.

As shown in FIGS. 2 and 3, the powder removal section 9 is located on the first guide rail 12, and removes unnecessary raw material powder from the layered body 25 dried in the drying section 8. As shown in FIG. 2, the powder removal section 9 has a lifting mechanism 28 that moves the molding stage 14 up and down in the vertical direction.

The lifting mechanism 28 has a pedal 28a, and the unnecessary raw material powder around the layered body 25 can be removed by operating the pedal 28a to move the molding stage 14 of the molding container 15 located in the powder removal section 9 up and down in the vertical direction (Z-axis direction). In the powder removal section 9, the unnecessary raw material powder may be removed from the layered body 25 with an air gun, a suction nozzle, a brush, or the like.

The air gun can be placed on the top or side of the powder removal section 9 to supply air. The air is preferably the same as the shield gas supplied into the housing 2.

When the unnecessary raw material powder is removed with an air gun, it is preferable to have a partition wall separating the drying section 8 and the powder removal section 9. By providing the partition wall, it is possible to prevent the raw material powder from scattering inside the housing 2. When a partition wall is provided, it is preferable that only the part through which the molding container 15 passes can be opened and closed.

The powder recovery section 10 is disposed below the work stage 11 (inside the lower space of the housing 2) as shown in FIG. 2. The powder recovery section 10 has a powder dropping member 29, an inclined member 30, and a recovery container 31 as shown in FIGS. 2 and 3.

The powder dropping member 29 is a plate-molded member having a plurality of holes penetrating from the upper surface to the lower surface. The powder dropping member 29 is disposed on the work stage 11 at the area in which the replacement section 17, the drying section 8, and the powder removal section 9 are arranged. The powder dropping member 29 is not particularly limited, but may be, for example, a punching board having a plurality of through-holes or a member having a mesh structure.

As shown in FIG. 2, the inclined member 30 is a cylindrical member having a funnel function, and its upper opening is connected to the work stage 11 so as to cover the lower part of the powder dropping member 29, and its lower opening is connected to the entrance of the recovery container 31.

The recovery container 31 is an airtight container capable of storing the raw material powder. The recovery container 31 can be separated and removed from the housing 2 in a sealed state.

Since the powder recovery section 10 is arranged below the replacement section 17, the drying section 8, and the powder removal section 9, the raw material powder that has been dropped from the molding container 15 in the replacement section 17, the drying section 8, and the powder removal section 9 can be recovered in the recovery container 31 via the powder dropping member 29 and the inclined member 30.

In addition, except for the replacement section 17, the drying section 8, and the powder removal section 9, the raw material powder that has spilled onto the upper surface 11a of the work stage 11 can be collected in the recovery container 31 by dropping it downward from the powder dropping member 29 with an air gun, a suction nozzle, a brush, or the like. The cylindrical space inside the inclined member 30 and the space inside the recovery container 31 are made to have a shield gas atmosphere.

As shown in FIGS. 2 and 3, the housing 2 has a first transfer chamber 32 and a second transfer chamber 33 in the upper space inside the housing 2. The first transfer chamber 32 and the second transfer chamber 33 have the function of exhausting the internal atmosphere and replacing it with the shield gas. This makes it possible to transfer materials between the inside and outside of the housing 2 while maintaining the shield gas atmosphere inside the housing 2.

In the present embodiment, the first transfer chamber 32 allows the layered body 25 after drying to be taken out from the inside of the housing 2 to the outside.

In addition, the second transfer chamber 33 allows a raw material powder container 34 to be brought from the outside to the inside of the housing 2. This allows the raw material powder to be replenished in the powder storage portion 20 of the molding section 7 in a shield gas atmosphere, thereby preventing oxidation of the raw material powder and moisture absorption by the raw material powder.

As shown in FIG. 2, the housing 2 has a supply port 2a for supplying the shield gas into an upper space inside the housing 2, and an exhaust port 2b for exhausting an atmospheric gas inside the housing 2. The manufacturing device 1 of the present embodiment can form a shield gas atmosphere in the space inside the housing 2 by exhausting the atmospheric gas inside the housing 2 and supplying the shield gas.

The shield gas is not particularly limited and can be appropriately selected depending on the type of raw material powder. As the shield gas, an inert gas is preferable, and among these, nitrogen gas and argon gas are more preferable. Depending on the type of raw material powder, a shield gas containing an oxidizing gas such as oxygen that reacts with the raw material may be used. When a shield gas containing an oxidizing gas other than an inert gas is used, the raw material powder and the oxidizing gas react with each other to form an oxide film on the surface of the raw material powder.

The analysis unit 3 analyzes the components of the atmospheric gas (shield gas atmosphere) in the space within the housing 2. As shown in FIGS. 1 and 2, the analysis unit 3 is located on the secondary side of the housing 2 in the flow direction of the shield gas. The analysis unit 3 preferably has either one or both of a hydrogen concentration meter and a moisture concentration meter. This makes it possible to detect the hydrogen concentration or moisture concentration in the atmospheric gas discharged from the space within the housing 2 (that is, the atmospheric gas within the housing 2).

The hydrogen concentration in the atmosphere gas in the housing 2 is preferably set to an upper limit of 4% or less. Incidentally, the binder used in the molding section 7 may contain moisture. This moisture may react with the raw material powder to generate hydrogen. Therefore, by setting the upper limit of the hydrogen concentration at 4%, an explosion due to hydrogen can be prevented.

The moisture concentration in the atmospheric gas in the housing 2 is preferably 1,000 ppm or less. By setting the upper limit of the moisture concentration at 1,000 ppm, it is possible to suppress moisture adsorption to the raw material powder and prevent a decrease in the fluidity of the raw material powder.

The analysis unit 3 preferably further includes an oxygen concentration meter, a binder component concentration meter, and the like. This makes it possible to analyze the oxygen concentration and binder component concentration in the atmospheric gas in the housing 2.

The upper limit of the oxygen concentration in the atmospheric gas in the housing 2 is preferably 20,000 ppm or less, and more preferably 10,000 ppm or less from the viewpoint of preventing oxidation of the raw material powder. Furthermore, when the raw material powder is a highly active metal such as a titanium alloy or an aluminum alloy, the lower limit of the oxygen concentration in the atmospheric gas in the housing 2 is preferably 1,000 ppm or more. Setting the lower limit of the oxygen concentration to 1,000 ppm promotes surface oxidation of the raw material powder, and can prevent rapid oxidation, heat generation, and explosion.

The binder component concentration in the atmospheric gas inside the housing 2 is preferably 10,000 ppm or less, more preferably 5,000 ppm or less, even more preferably 2,000 ppm or less, and particularly preferably 1,000 ppm or less. By setting the upper limit of the binder component concentration at 10,000 ppm, it is possible to suppress ignition of the binder component, adhesion to the layered object, and adhesion to the raw material powder.

The concentration of each component in the atmospheric gas inside the housing 2 can be adjusted by the amount of shield gas supplied into the housing 2. That is, by increasing the amount of shield gas supplied into the housing 2, the concentration of each component can be reduced.

The control unit 4 has a function of controlling the atmosphere gas (shield gas atmosphere) in the space within the housing 2 to have required components. Specifically, the control unit 4 may calculate the supply amount of shield gas into the housing 2 based on the measured values of the concentrations of each component in the atmosphere gas obtained from the analysis unit 3, and send a supply signal (control signal) to a shield gas supply unit (shield gas supply source) 5.

The control unit 4 may be configured to include a central processing unit (CPU), a memory, and a hard disk drive. The hard disk drive may include a CAD application and a CAM (Computer-Aided Manufacturing) application. In this case, the control unit 4 can create three-dimensional structural data of a layered structure of a desired shape.

The control unit 4 may be configured to create processing condition data based on the three-dimensional structure data. Processing condition data can be created for each molded solidified layer.

The control unit 4 may control the powder bed forming portion 18 and the binder applying portion 19 based on the processing condition data, and adjust the amount of binder applied, the nozzle scanning speed, the scanning interval, and the application position.

The shield gas supply unit 5 is a shield gas supply source that supplies the shield gas into the housing 2. The mode of the shield gas supply source is not particularly limited and can be appropriately selected depending on the type and amount of shield gas used. A gas cylinder, a cold evaporator (CE), a PSA device, and the like can be used. When nitrogen gas is used as the shield gas, it is preferable to use a nitrogen PSA device that uses air as the raw material as the shield gas supply unit 5. By using a nitrogen PSA device as the shield gas supply unit 5, nitrogen gas containing a trace amount of oxygen can be supplied into the housing 2 as the shield gas.

The exhaust gas treatment unit 6 treats the atmospheric gas discharged from the housing 2 as exhaust gas. The exhaust gas treatment unit 6 is not particularly limited and can be appropriately selected depending on the type of shield gas and the atmospheric gas in the housing 2. For example, a decontamination device such as a water scrubber, a filter, a trap device, and the like can be used as the exhaust gas treatment unit 6. By providing the exhaust gas treatment unit 6, when at least one of the binder, the vaporized solvent released by vaporizing the binder, and a solvent (for example, organic solvent) contained in the binder is discharged, it can be treated by the exhaust gas treatment unit 6 and is not released to the outside, thereby preventing health damage.

### <Layered Structure Manufacturing Method>

Next, a layered structure manufacturing method, which is one embodiment according to the present invention, will be described using the manufacturing device 1 as an example.

The layered structure manufacturing method of the present embodiment is a layered structure manufacturing method in which a layered structure is obtained by layering the plurality of molded solidified layers 25a formed by applying the binder to the powder bed 22 of the raw material powder, wherein the molded solidified layers 25a are formed in a shield gas atmosphere containing required components, a layered body 25 is manufactured by stacking the molded solidified layers 25a, the layered body 25 is heated and dried, and unnecessary raw material powder is removed from the dried layered body 25.

Specifically, the layered structure manufacturing method of the present embodiment performs the following steps.

### (Atmospheric Gas Adjustment Step)

The atmospheric gas adjustment step adjusts the atmospheric gas in the housing 2 to create a shield gas atmosphere containing required components.

First, the shield gas is supplied from the shield gas supply unit 5 into the housing 2 via the supply port 2a. The atmospheric gas in the housing 2 is exhausted from the exhaust port 2b. At this time, the analysis unit 3 analyzes the oxygen concentration, hydrogen concentration, moisture concentration, and binder concentration in the atmospheric gas (shield gas atmosphere) in the space inside the housing 2.

Supply of the shield gas into the housing 2 and analysis of the concentration of each component in the atmospheric gas in the housing 2 are continued, and when the concentration of each component in the atmospheric gas in the housing 2 falls below a required value, the molding step is started. When the concentration of each component in the atmospheric gas in the housing 2 falls below a required value, the control unit 4 may control to reduce the supply amount of the shield gas.

The adjustment of the atmospheric gas in the housing 2 continues during the molding step, drying step, layered body removal step, and raw material powder replenishment step, which will be described later. The concentration of each component in the atmospheric gas in the housing 2 is monitored by analysis by the analysis unit 3, and the supply amount of the shield gas is adjusted, so that the oxygen concentration, hydrogen concentration, moisture concentration, and binder concentration can be controlled so as not to exceed their upper limit values.

### (Molding Step)

In the molding step, a molded solidified layer 25a is formed, and the layered body 25 is molded by layering the molded solidified layers 25a.

First, as shown in FIG. 2 and FIG. 3, the unprocessed molding container 15 waiting on the second guide rail 13 is moved along the second guide rail 13 to the position of the replacement section 17, and then moved along the first guide rail 12 to the position of the molding section 7.

Next, as shown in FIG. 4, the powder bed forming portion 18 is operated to supply and spread the raw material powder from the powder storage portion 20 into the molding container 15 while allowing it to fall naturally, thereby forming a raw material powder layer of a predetermined thickness on the molding stage 14. The raw material powder layer is smoothed by the recoater 21 that moves in conjunction with the powder storage portion 20 so that the surface is flat and of uniform thickness. In this manner, the powder bed 22 is formed on the molding stage 14. The thickness of the raw material powder layer is, for example, about 40~50 μm, but is appropriately set within a range of approximately 100 μm or less.

Next, as shown in FIG. 5, the binder applying portion 19 is operated to selectively spray the binder from the binder applying nozzle 23 onto the raw powder layer (powder bed 22) layered on the molding stage 14. The raw powder at the portion where the binder is sprayed is then heated by the binder solidification heat source section 24, and the binder solidifies, bonding and hardening the raw powder. In this way, the molded solidified layer 25a is formed on the molding stage 14. The binder applying nozzle 23 can be computer-controlled by the control unit 4 based on three-dimensional data corresponding to the shape of the desired three-dimensional sintered body (layered structure) and driven on the raw powder layer.

Next, raw powder is again supplied from the powder storage portion 20 onto the first raw powder layer contained in the molded solidified layer 25a formed by bonding by selectively applying the binder, and the layer is flattened by the recoater 21 to form a second raw powder layer. Next, a binder is selectively sprayed from the binder applying nozzle 23 onto the second raw powder layer, bonding the raw powder with the binder to form the molded solidified layer 25a.

In this way, the layered body 25 in which the molded solidified layers 25a are layered is produced inside the powder bed 22 including multiple raw powder layers by repeatedly carrying out the step in which the raw powder is layered on the first raw powder layer including the molded solidified layer 25a bonded by selectively applying the binder to form the next raw powder layer, and then the binder is selectively sprayed onto the next raw powder layer.

In order to form an integrated layered body 25, adjacent overlapping molded solidified layers 25a are bonded to each other at least partially by overlapping the binder supply portions, thereby forming a layered body 25 that is continuous vertically (in the Z-axis direction).

### (Drying Step)

In the drying step, the layered body 25 is heated and dried.

First, as shown in FIGS. 2 and 3, the molding container 15, for which the molding step has been completed, is moved along the first guide rail 12 from the molding section 7 to the position of the drying section 8. At this time, the heating chamber 27 is retracted upward in the Z-axis direction. Next, after the molding container 15 is transported to the drying section 8, the heating chamber 27 is lowered downward in the Z-axis direction to arrange the molding container 15 inside the heating chamber 27. In this state, the layered body 25 is heated by the heat source 26 and dried.

The layered body 25 in the molding container 15 is dried by volatilizing the binder component in the drying step. It is preferable that the layered body 25 be completely dried to the inside, but it is acceptable for some parts to be in an undried state.

After the molding container 15 for which the molding step has been completed is moved along the first guide rail 12 from the molding section 7 to the position of the drying section 8, a new molding container 15 that has been waiting on the second guide rail 13 of the replacement section 17 is moved to the molding section 7. Then, in the molding section 7, the molding step is started using the new molding container 15 in parallel with the drying step. Thus, although it takes time to dry the layered body 25 in the drying step, according to the layered structure manufacturing method of the present embodiment, the production efficiency can be improved by starting the molding step of the new molding container 15 in parallel with the drying step.

### (Removal Step)

In the removal step of the layered body 25, unnecessary raw material powder is removed from the dried layered body 25.

First, the molding container 15, for which the drying step has been completed, is moved along the first guide rail 12 from the drying section 8 to the position of the powder removal section 9. At this time, the heating chamber 27 is retracted upward in the Z-axis direction. Next, after the molding container 15 is transported to the powder removal section 9, the pedal 28a of the lifting mechanism 28 is operated to swing the molding stage 14 of the molding container 15 up and down in the vertical direction (Z-axis direction), thereby removing unnecessary raw material powder around the layered body 25. Note that the method of removing the raw material powder is not particularly limited, and unnecessary raw material powder may be removed from the layered body 25 using an air gun, suction nozzle, brush, or the like.

### (Layered Body Removing Step)

Next, the layered body 25 after removing unnecessary raw material powder is removed from the first transfer chamber 32 to the outside of the housing 2. At this time, it is preferable to gradually open the outer door of the first transfer chamber 32 and gradually replace the atmosphere in the first transfer chamber 32 with air. The speed at which air is introduced into the first transfer chamber 32 is preferably set to a flow rate that can replace the atmosphere in the first transfer chamber 32 in 10 seconds to 10 minutes. In this way, by gradually increasing the oxygen concentration in the first transfer chamber 32 until it becomes the same as the atmosphere outside the housing 2, it is possible to prevent a sudden reaction between the raw material powder contained in the layered body 25 and oxygen.

### (Sintering Step)

Next, the dried layered body 25 removed from the housing 2 is sintered to obtain a sintered body (layered structure).

Specifically, a heating device such as an oven capable of heating at the required temperature is used to sinter the layered body 25 under the required sintering conditions.

In this way, according to the layered structure manufacturing method of the present embodiment, the layered structure can be obtained in a simple step.

### (Replenishing Raw Material Powder Step)

The layered structure manufacturing method of the present embodiment includes, in addition to the steps described above, a step of replenishing raw material powder.

Specifically, in the molding section 7 in the housing 2, the powder storage portion 20 constituting the powder bed forming portion 18 is periodically replenished with raw material powder.

First, the outer door of the second transfer chamber 33 located at the top of the housing 2 is opened, and a raw material powder container 34 containing the raw material powder is placed inside the chamber, and then the door is closed.

Next, the atmosphere in the second transfer chamber 33 is evacuated and then replaced with the shield gas. This creates a shield gas atmosphere in the second transfer chamber 33. After the shield gas atmosphere is created in the second transfer chamber 33, the door on the inside (housing 2 side) of the second transfer chamber 33 is opened, and the raw material powder container 34 is taken out into the space inside the housing 2. Next, the raw material powder container 34 is opened, and the powder storage portion 20 of the powder bed forming portion 18 is replenished with raw material powder.

In this way, according to the layered structure manufacturing method of the present embodiment, raw material powder can be replenished to the powder storage portion 20 of the molding section 7 in a shield gas atmosphere, so that oxidation of the raw material powder and moisture adsorption by the raw material powder can be prevented.

### (Control by Control Unit 4)

In the layered structure manufacturing method of the present embodiment, some or all of the atmospheric gas adjustment step, the molding step, and the drying step, as well as the movement of the molding container 15 within the housing 2, can be performed automatically by control signals from the control unit 4.

In addition, in the layered structure manufacturing method of the present embodiment, as shown in FIG. 1, the control unit 4 is electrically connected to the analysis unit 3 and the shield gas supply unit 5, so that the shield gas atmosphere in the housing 2 may be automatically controlled by the control unit 4.

Specifically, when the analysis unit 3 has an oxygen concentration meter, the control unit 4 sets the lower limit of the oxygen concentration in the atmospheric gas in the housing 2 to 0% and the upper limit to 1%, and the oxygen concentration reaches the lower limit, the supply amount (flow rate) of the shield gas can be reduced. On the other hand, when the oxygen concentration exceeds the upper limit, the supply amount (flow rate) of the shield gas can be increased and the molding step and the drying step can be stopped. Furthermore, when the oxygen concentration exceeds the upper limit, the opening and closing of the housing upper opening door 16, the first transfer chamber 32, and the second transfer chamber 33 can be restricted (locked) from the viewpoint of safety.

In addition, when the analysis unit 3 has a hydrogen concentration meter, the control unit 4 sets the lower limit of the hydrogen concentration in the atmospheric gas in the housing 2 to 0% and the upper limit to 4%, and the hydrogen concentration reaches the lower limit, the supply amount (flow rate) of the shield gas can be reduced. On the other hand, when the hydrogen concentration exceeds the upper limit, the supply amount (flow rate) of the shield gas can be increased and the molding step and the drying step can be stopped.

Furthermore, the opening and closing of the housing upper opening door 16, the first transfer chamber 32, and the second transfer chamber 33 can be controlled (locked). This makes it possible to block the inflow of oxygen from the outside into the housing 2. For example, when a highly active metal powder is used as the raw material powder, it is possible to prevent the atmosphere inside the housing 2 from deviating from the range for safe operation due to hydrogen generated by the reaction between water and the metal.

In addition, when the analysis unit 3 also has a moisture concentration meter, the control unit 4 sets the lower limit of the moisture concentration in the atmospheric gas in the housing 2 to 0% and the upper limit to 0.1%, and the moisture concentration reaches the lower limit, the supply amount (flow rate) of the shield gas can be reduced. On the other hand, when the moisture concentration exceeds the upper limit, the supply amount (flow rate) of the shield gas can be increased and the molding step and the drying step can be stopped. When the moisture concentration exceeds the upper limit, the opening and closing of the housing upper opening door 16, the first transfer chamber 32, and the second transfer chamber 33 can be restricted (locked) from the viewpoint of safety.

In addition, when the analysis unit 3 has a binder component concentration meter, the control unit 4 sets the lower limit of the binder component concentration in the atmospheric gas in the housing 2 to 0% and the upper limit to 0.1%, and the binder component concentration reaches the lower limit, the supply amount (flow rate) of the shield gas can be reduced. On the other hand, when the binder component concentration exceeds the upper limit, the supply amount (flow rate) of the shield gas can be increased and the molding step and the drying step can be stopped. In addition, when the binder component concentration exceeds the upper limit, the opening and closing of the housing upper opening door 16, the first transfer chamber 32, and the second transfer chamber 33 can be restricted (locked) from the viewpoint of safety.

Furthermore, when the analysis unit 3 has an oxygen concentration meter and a hydrogen concentration meter, the control unit 4 sets a safe operating range (for example, a safe range generally indicated by a hydrogen-air-nitrogen triangle figure) in the atmospheric gas in the housing 2, and both the oxygen concentration and the hydrogen concentration are within the safe operating range, the supply amount (flow rate) of the shield gas can be reduced. On the other hand, when at least one of the oxygen concentration and the hydrogen concentration is outside the safe operating range, the supply amount (flow rate) of the shield gas can be increased and the molding step and the drying step can be stopped. The opening and closing of the housing upper opening door 16, the first transfer chamber 32, and the second transfer chamber 33 can be restricted (locked) from the viewpoint of safety.

Furthermore, in the layered structure manufacturing method of the present embodiment, as shown in FIG. 1, the control unit 4 is electrically connected to the housing 2, the shield gas supply unit 5, and the exhaust gas treatment unit 6, so that when various abnormal signals are detected, the control unit 4 can automatically stop the operation of each unit.

Specifically, if the control unit 4 detects an abnormality in the shield gas supply unit 5, it can stop the molding step and the drying step.

If the control unit 4 detects overheating in the drying section 8, it can increase the supply amount (flow rate) of shield gas and stop the molding step and the drying step.

If the control unit 4 detects an abnormality in each concentration meter in the analysis unit 3, it can stop the molding step and the drying step.

If the control unit 4 detects an abnormality in the exhaust gas treatment unit 6, it can stop the molding step and the drying step.

As described above, according to the layered structure manufacturing method of the present embodiment, a layered structure can be safely manufactured.

As described above, according to the layered structure manufacturing device 1 and manufacturing method of the present embodiment, the molding section 7 and the drying section 8 are arranged in the housing 2, and the molding step and the drying step can be continuously performed in a required shield gas atmosphere. Therefore, with a simple device configuration, the layered body 25, which serves as a precursor of the layered structure, can be easily obtained.

In addition, the layered structure manufactured by sintering the layered body 25 obtained by the layered structure manufacturing device 1 and the manufacturing method of the present embodiment has an advantageous effect on various products in a wide range of industrial fields. For example, the layered structure has an advantage of being able to satisfy various requirements for characteristics.

The technical scope of the present invention is not limited to the above embodiments, and various modifications can be made without departing from the spirit of the present invention. In the manufacturing device 1 and manufacturing method described above, the analysis unit 3 has a hydrogen concentration meter and a moisture concentration meter, but is not limited to this embodiment. For example, the analysis unit 3 may not have a hydrogen concentration meter.

Specifically, the analysis unit 3 may be configured to have an oxygen concentration meter and a moisture concentration meter.

When a highly active metal powder is used as the raw material powder, hydrogen may be produced by the reaction between water and the metal powder. In this case, it is preferable to predict the amount of moisture and the amount of hydrogen produced depending on the type of metal powder and set an upper limit for the moisture concentration in the atmospheric gas in housing 2.

The control unit 4 sets a safe operation range (for example, a safe operation range indicated by a hydrogen-air-nitrogen triangle) based on the oxygen concentration and moisture concentration (the amount of hydrogen generated predicted from the oxygen concentration and moisture concentration) in the atmospheric gas in the housing 2, and when the oxygen concentration and moisture concentration are within the safe operation range, the supply amount (flow rate) of the shield gas can be reduced. On the other hand, when at least one of the oxygen concentration and moisture concentration is outside the safe operation range, the supply amount (flow rate) of the shield gas can be increased and the molding step and the drying step can be stopped. In addition, from the viewpoint of safety, the opening and closing of the housing upper opening door 16, the first transfer chamber 32, and the second transfer chamber 33 can be restricted (locked).

### EXPLANATION OF SYMBOLS

1 Manufacturing device (layered structure manufacturing device)
2 Housing
3 Analysis unit
4 Control unit
5 Shield gas supply unit (shield gas supply source)
6 Exhaust gas treatment unit
7 Molding section
8 Drying section
9 Powder removal section
10 Powder recovery section
11 Work stage
11a Upper surface (flat surface)
12 First guide rail
13 Second guide rail
14 Molding stage
15 Molding container
16 Housing upper opening door
17 Replacement section
18 Powder bed forming portion
19 Binder applying portion
20 Powder storage portion
21 Recoater
22 Powder bed
23 Binder applying nozzle
24 Heat source section
25 Layered body (Green part)
25a Molded solidified layer

1. A layered structure manufacturing device for manufacturing a layered structure by layering multiple molded solidified layers formed by applying a binder to a powder bed of raw material powder, comprising:
a housing for forming a shield gas atmosphere in an inner space thereof;
an analysis unit for analyzing components of the shield gas atmosphere;
a control unit having the function of controlling the shield gas atmosphere to have required components;
a molding section for forming molded solidified layers and molding a layered body in which the molded solidified layers are layered;
a drying section for heating and drying the layered body;
a powder removal section for removing unnecessary raw material powder from the dried layered body; and
a powder recovery section for recovering the unnecessary raw material powder,
wherein the molding section, the drying section, the powder removal section, and the powder recovery section are located in the inner space of the housing.

2. The layered structure manufacturing device according to claim 1,
wherein the housing has a plane that divides the space of the housing in the vertical direction, and
wherein the molding section, the drying section, and the powder removal section are located in the space above the plane.

3. The layered structure manufacturing device according to claim 2,
wherein the molding section, the drying section, and the powder removal section are arranged in this order in one direction on the plane.

4. The layered structure manufacturing device according to claim 3,
wherein the layered structure manufacturing device further comprises a first guide rail arranged along the one direction, and
wherein a molding container having a molding stage moves on the first guide rail.

5. The layered structure manufacturing device according to claim 4,
wherein the powder removal section has a lifting mechanism that moves the molding stage up and down in the vertical direction.

6. The layered structure manufacturing device according to claim 4,
wherein the layered structure manufacturing device further comprises a second guide rail arranged along another direction intersecting the one direction on the plane,
wherein the first guide rail and the second guide rail intersect between the molding section and the drying section, and
wherein the molding container moves on the first guide rail and the second guide rail.

7. The layered structure manufacturing device according to claim 1,
wherein the analysis unit has either one or both of a moisture concentration meter and a hydrogen concentration meter.

8. The layered structure manufacturing device according to claim 1,
wherein the layered structure manufacturing device further comprises a nitrogen PSA device using air as a raw material as a shield gas supply source for supplying a shield gas into the housing.

9. A layered structure manufacturing method for manufacturing a layered structure by layering multiple molded solidified layers formed by applying a binder to a powder bed of raw material powder, comprising:
a molding step of forming molded solidified layers and molding a layered body by layering the molded solidified layers in a shielding gas atmosphere containing required components;
a drying step of heating and drying the layered body in a shielding gas atmosphere containing required components; and
a removal step of removing unnecessary raw material powder from the layered body that has been dried in a shielding gas atmosphere containing required components.

10. The layered structure manufacturing method according to claim 9,
wherein either or both of a moisture concentration and a hydrogen concentration of the shield gas atmosphere are controlled in the molding step, the drying step, and the removal step.

11. The layered structure manufacturing method according to claim 9,
wherein the shield gas atmosphere contains oxygen in the molding step, the drying step, and the removal step.

12. The laminated structure manufacturing apparatus according to claim 1,
wherein a work stage is provided inside the housing;
wherein at least one of the work stage and the powder removal section has at least one of an air gun, a suction nozzle, and a brush; and
wherein at least one of the air gun, the suction nozzle, and the brush removes unnecessary raw material powder from the layered body.
